(19) United States
(12) Patent Application Publication
(10) Pub. No.: US 2013/0086397 A1
(43) Pub. Date: Apr. 4, 2013

(54) ELECTRONIC APPARATUS AND ITS CONTROL METHOD

(71) Applicant: Katsuhiro Uchida, Ome-shi (JP)

(72) Inventor: Katsuhiro Uchida, Ome-shi (JP)

(21) Appl. No.: 13/495,665

(22) Filed: Jun. 13, 2012

(30) Foreign Application Priority Data
Sep. 30, 2011 (JP) 2011-218682

(51) Int. Cl. G06F 1/26

(52) U.S. Cl. 713/300

(57) ABSTRACT

One embodiment provides an electronic apparatus, including: a first power supply module configured to supply power to a storage device provided in an external device when the external device is connected to the electronic apparatus; a receiving module configured to receive, from the external device, identification information thereof; and a second power supply module configured to supply power to an input/output control module of the external device if authentication of the identification information received by the receiving module succeeds.

### CROSS-REFERENCE TO RELATED APPLICATION(S)

This application claims priority from Japanese Patent Application No. 2011-218682 filed on Sep. 30, 2011, the entire contents of which are incorporated herein by reference.

### FIELD

Embodiments described herein relate generally to an electronic apparatus and its control method.

### BACKGROUND

An external device called a docking station is known which was developed to charge an electronic apparatus and extend its functions. And individual components of an electronic apparatus are controlled according to a state of its connection to a docking station. For example, it is disclosed that, in the case of an electronic apparatus whose cabinet surface is provided with a bus connector for extension of an internal input/output bus to the outside, a bus signal is on/off-switched according to a state of its connection to a docking station.

In recent years, rectangular, flat electronic apparatus classified as a slate type have come to be marketed and docking stations for slate-type electronic apparatus have been developed. In slate-type electronic apparatus, a connector for connection to a docking station is exposed in a side surface. Even when such slate-type electronic apparatus has a cover for protecting such a connector, the cover tends to come off the electronic apparatus when the user uses it while holding it. In either case, a foreign thing is more prone to come into contact with the connector of a slate-type electronic apparatus than that of a notebook personal computers etc. Thus, in slate-type electronic apparatus, a short-circuit may occur in a connector portion at a relatively high probability.

### BRIEF DESCRIPTION OF DRAWINGS

A general architecture that implements the various features of the present invention will now be described with reference to the drawings. The drawings and the associated descriptions are provided to illustrate embodiments and not to limit the scope of the present invention.

FIG. 1 illustrates use forms of an electronic apparatus according to an embodiment.

FIG. 2 illustrates a system configuration of the electronic apparatus and a docking station according to the embodiment.

FIG. 3 illustrates a configuration relating to power control in the electronic apparatus.

FIG. 4 illustrates a power control process of the electronic apparatus.

### DETAILED DESCRIPTION

One embodiment provides an electronic apparatus, including: a first power supply module configured to supply power to a storage device provided in an external device when the external device is connected to the electronic apparatus; a receiving module configured to receive, from the external device, identification information thereof; and a second power supply module configured to supply power to an input/output control module of the external device if authentication of the identification information received by the receiving module succeeds.

An embodiment will be hereinafter described with reference to the drawings.

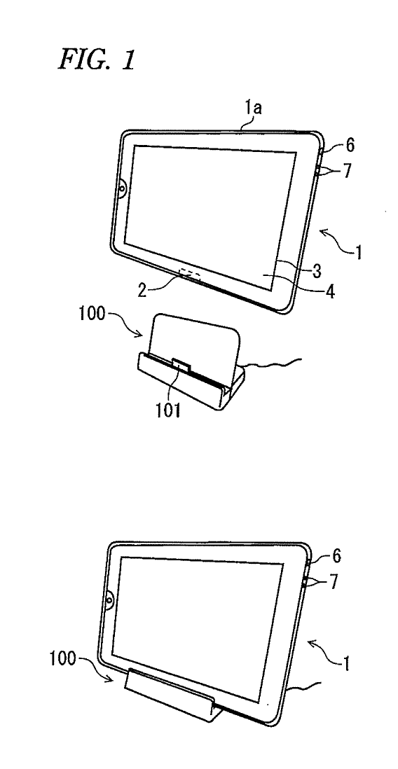

FIG. 1 illustrates use forms of an electronic apparatus 1 according to the embodiment. First, a description will be made of external structures of the electronic apparatus 1 and a docking station 100. As shown in FIG. 1, the electronic apparatus 1 has a rectangular, flat shape. The electronic apparatus 1 is a personal computer, a TV receiver, a smartphone, a cell phone, or the like of the slate type, the tablet type (a display device having a software keyboard function), or the like.

The electronic apparatus 1 has an LCD (liquid crystal display) 3 which is a display unit, a power switch 6, and LEDs (light-emitting diodes) 7 such that they are exposed in surfaces of a cabinet 1a. A touch panel 4 is provided on the display surface of the LCD 3, and the LCD 3 and the touch panel 4 thus constitute a touch screen display. The touch screen display detects a touch area (also called a touch position), touched by a pen or a finger, on the display screen. The user performs various manipulations by manipulating the touch panel 4 and the power switch 6.

The power switch 6 is provided on a side surface of the cabinet 1a so as to be exposed, and receives a manipulation input for powering on or off the electronic apparatus 1. The LEDs 7 are devices which emit light to notify the user of an operation state of the electronic apparatus 1. The LEDs 7 can indicate various operation states by combinations of light emission colors and lighting/flashing.

The electronic apparatus 1 has a connector 2 for connection to the docking station 100. The connector 2 is provided in an opening that is formed in a side surface of the cabinet 1a, so as to be exposed to the outside. For example, power, various data, a video signal, an audio signal, etc. are exchanged between the electronic apparatus 1 and the docking station 100 via (the terminals of) the connector 2.

Next, the docking station 100 according to the embodiment will be described. When connected to the electronic apparatus 1, the docking station 100 can add a connector to ones provided in the electronic apparatus 1 originally, extend a function provided in the electronic apparatus 1 originally, or add a function that is not provided in the electronic apparatus 1 originally. That is, the docking station 100 is an example function extending device for the electronic apparatus 1.

As shown in FIG. 1, the docking station 100 according to the embodiment supports, in an erected posture, the electronic apparatus 1 which is relatively thin and flat. That is, the docking station 100 is an example of a support device, a holding device, a support stage, a support member, a placement stage, and a holder for the electronic apparatus 1.

The docking station 100 has a first connector 101 (connection portion, connection region) to be connected to the connector 2 (connection portion, connection region) of the electronic apparatus 1. The docking station 100 supports the electronic apparatus 1 in a state that the first connector 101 and the connector 2 are connected to each other.

The back surface of the docking station 100 has a second connector (not shown in FIG. 1) for connection to a connector other than the connector 2 of the electronic apparatus 1 (i.e., a connector of another electronic apparatus). As such, the docking station 100 is also an example of an intermediary device to mediate between the electronic apparatus 1 and another electronic apparatus (not shown) or the like.

So that the docking station 100 can function as a function extending device, a connection device, an intermediary device, or the like as described above, a cabinet of the docking station 100 houses a circuit board (printed circuit board), electronic components, electric components, wiring, etc. as modules and components in addition to the first connector 101 and the second connector.

In the embodiment, two use forms, that is, an undocked state (top part of FIG. 1) and a docked state (bottom part of FIG. 1), are available. In the undocked state, the user uses the electronic apparatus 1 while holding it with his or her hand and performs a manipulation by touching the touch panel 4 with his or her finger or the like. In the docked state, the electronic apparatus 1 can be charged or its function can be extended.

Since the connector 2 is exposed in the opening that is formed in the side surface of the cabinet 1a, a foreign thing such as a metal pin tends to contact it. Therefore, if the electronic apparatus 1 is configured so as to supply power to every terminal (pin) of the connector 2, the probability that a short-circuit occurs in the connector 2 is high. How the embodiment prevents a short-circuit from occurring inadvertently in the connector 2 and thereby increases the electric safety of the electronic apparatus 1 will be described below.

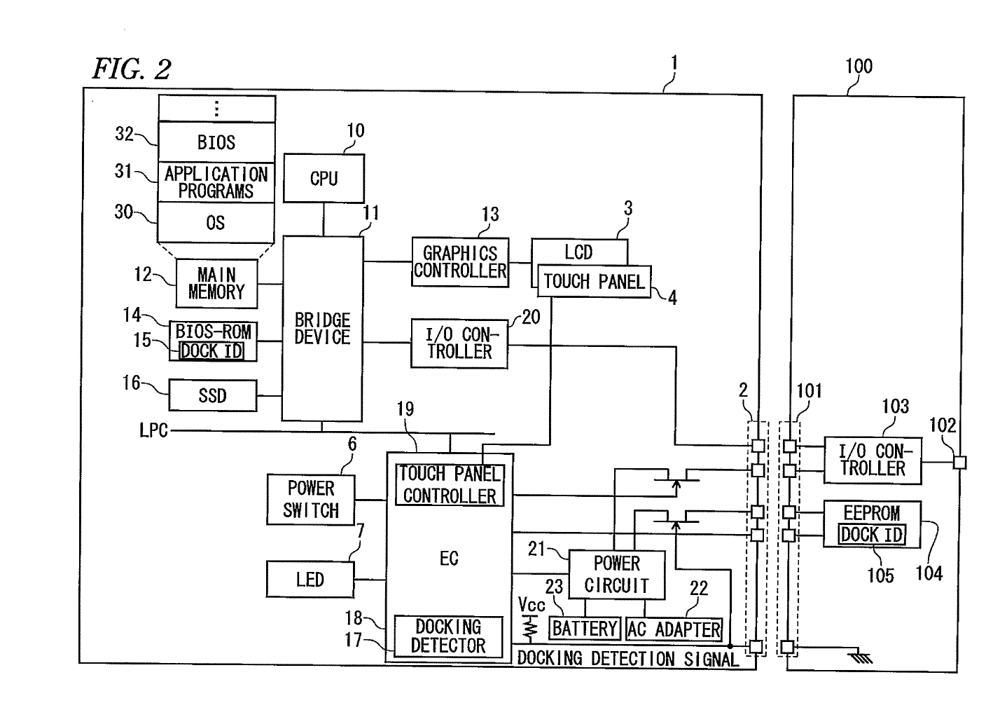

FIG. 2 illustrates a system configuration of the electronic apparatus 1 and the docking station 100 according to the embodiment. The electronic apparatus 1 has a CPU (central processing unit) 10, a bridge device 11, a main memory 12, a graphics controller 13, a BIOS-ROM (basic input/output system-read only memory) 14, an SSD (solid-state drive) 16, an embedded controller (EC) 18, an I/O (input/output) controller 20, a power circuit 21, etc. The BIOS-ROM 14 stores a dock ID 15. The embedded controller 18 includes a docking detector 17 and a touch panel controller 19.

The CPU 10 is a processor for controlling operations of the individual components of the electronic apparatus 1. The CPU 10 runs an operating system (OS) 30 and various utility/application programs 31 that are read from the SSD 16 into the main memory 12. The CPU 10 also runs a BIOS that is stored in the BIOS-ROM 14. The BIOS is hardware control programs.

The bridge device 11 has a function of communicating with the graphics controller 13. The graphics controller 13 is a display controller for controlling the LCD 3 which is used as a display of the electronic apparatus 1.

The bridge device 11 incorporates a memory controller for controlling the main memory 12. Furthermore, the bridge device 11 communicates with individual devices on a PCI (peripheral component interconnect) bus and individual devices on an LPC (low pin count) bus.

The main memory 12 is a temporary storage area into which the OS 30, the various application programs 31, and other programs are read from the SSD 16 so as to be run by the CPU 10.

The graphics controller 13 performs display processing (graphics computation) for drawing display data in a video memory (VRAM) according to a drawing request that is received from the CPU 10 via the bridge device 11. Video data corresponding to a screen image to be displayed on the LCD 3 is stored in the video memory.

The BIOS-ROM 14 stores a system BIOS 32 which is programs for controlling the hardware of the electronic apparatus 1. The BIOS-ROM 14 also stores identification information (dock ID 15) indicating the regular docking station 100. The dock ID 15 is set in advance before shipment of the electronic apparatus 1. In other words, the dock ID 15 is identification information indicating the docking station 100 that is correlated with the electronic apparatus 1.

The SSD 16 is a storage device for storing the OS 30 and the various application programs 31.

The embedded controller (EC) 18 has a function of powering on or off the electronic apparatus 1 according to a user manipulation on the power switch 6. That is, the embedded controller 18 controls the power circuit 21. The embedded controller 18 includes the touch panel controller 19 for controlling the touch panel 4 on the LCD 3. The embedded controller 18 is always kept operational irrespective of whether the electronic apparatus 1 is powered on or off.

The embedded controller 18 also includes the docking detector 17 for detecting connection of the connector 2 to the first connector 101 of the docking station 100. The docking detector 17 is connected to a docking detection signal line for detecting docking/undocking of the docking station 100. When the docking station 100 is connected to the electronic apparatus 1, the docking detection signal line is connected to a ground terminal of the docking station 100, whereby the level of a docking detection signal is changed from a high level to a low level because of presence of a pull-up resistor. On the other hand, when the docking station 100 is removed from the electronic apparatus 1, the docking detection signal line is disconnected from the ground terminal of the docking station 100, whereby the level of the docking detection signal is changed from the low level to the high level. The docking detector 17 detects connection/removal of the docking station 100 on the basis of such a potential variation of the docking detection signal.

The touch panel 4, which is of a resistive film type, a capacitance type, or the like, is configured so as to detect a touch area (touch position) on the touch panel 4 (touch screen display).

The I/O controller 20 is a controller for controlling an input/output device provided in the electronic apparatus 1 and an input/output device connected to an external connector. That is, the I/O controller 20 performs an input/output control in the electronic apparatus 1. Plural I/O controllers 20 may be provided in the electronic apparatus 1. Examples of the I/O controller 20 are a USB controller and a LAN controller.

When the first connector 101 is connected to the connector 2, the I/O controller 20 is electrically connected to an I/O controller 103 of the docking station 100 via a bus signal line.

While being supplied with external power via an AC adapter 22, the power circuit 21 generates system power to be supplied to the individual components of the electronic apparatus 1 using the external power being supplied. While not being supplied with external power via the AC adapter 22, the power circuit 21 generates system power using a battery 23.

The docking station 100 has the first connector 101, the second connector 102, the I/O controller 103, and an EEPROM 104. The first connector 101 is a connector for connection to the electronic apparatus 1, and the second connector 102 is a connector for connection to another electronic apparatus (not shown).

When the first connector 101 is connected to the connector 2 of the electronic apparatus 1, the I/O controller 103 is electrically connected to the I/O controller 20 of the electronic apparatus 1 via the bus signal line. The I/O controller 103 exchanges various data, control signals, etc. with the embedded controller 18 and another electronic apparatus (not shown) via the bus signal line. That is, the I/O controller 103 performs an input/output control in the docking station 100.

The I/O controller 103 is connected to the power circuit 21 of the electronic apparatus 1 via a power supply line. The power supply line is provided with a switch, and switching control as to whether to supply power to the I/O controller 103 can be performed through switching of this switch. Conventionally, when the docking station 100 is connected to the electronic apparatus 1, power is automatically supplied from the power circuit 21 to the I/O controller 103. In the embodiment, power is supplied to the docking station 100 only when it is judged that the connected docking station 100 is a regular one. Supplying power to the I/O controller 103 is, in other words, supplying power to the terminal, connected to the I/O controller 103, of the connector 2.

The EEPROM 104 stores identification information (dock ID 105) of the docking station 100. When the first connector 101 is connected to the connector 2, the EEPROM 104 is connected to the power circuit 21 of the electronic apparatus 1 and supplied with power from the power circuit 21. In other words, power is supplied to the EEPROM 104 being triggered by physical connection between the electronic apparatus 1 and the docking station 100.

When the first connector 101 is connected to the connector 2, the embedded controller 18 receives, via a serial interface, the identification information (dock ID 105) of the docking station 100 that is stored in the EEPROM 104. The embedded controller 18 informs the BIOS 32 of the received dock ID 105.

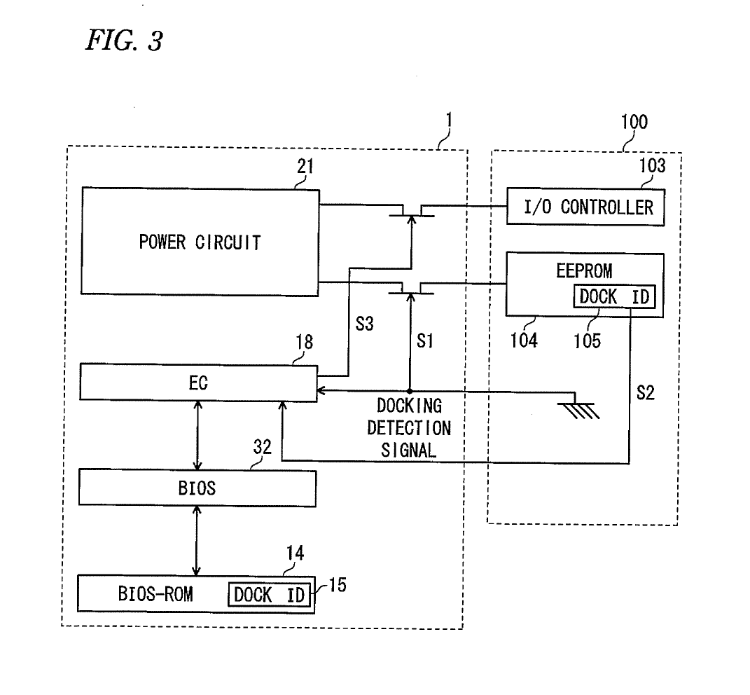

FIG. 3 illustrates a configuration relating to power control in the electronic apparatus 1 according to the embodiment. First, if detecting that the first connector 101 of the docking station 100 has been connected to the connector 2, at step S1 the docking detector 17 informs the embedded controller 18 that the level of the docking detection signal has changed to the low level and causes supply of power to the EEPROM 104. That is, the docking detector 17 turns on the switch of the power supply line provided between the power circuit 21 and the EEPROM 104.

At step S2, the embedded controller 18 receives the dock ID 105 from the EEPROM 104 via the serial interface. The embedded controller 18 informs the BIOS 32 of the received dock ID 105. The BIOS compares the received dock ID 105 with the regular dock ID 15 that is stored in the BIOS-ROM 14.

If the dock ID 105 coincides with the dock ID 15, at step S3 the BIOS 32 turns on the switch of the power supply line provided between the power circuit 21 and the I/O controller 103. On the other hand, if the dock ID 105 does not coincide with the dock ID 15, the BIOS 32 does not turn on the switch of the power supply line provided between the power circuit 21 and the I/O controller 103. That is, if the connected docking station 100 is not a regular one, no power is supplied from the power circuit 21 to the terminal that is connected to the I/O controller 103. Therefore, the electric safety can be increased without causing an inadvertent short-circuit at the connector 2 of the electronic apparatus 1 and power saving can be attained.

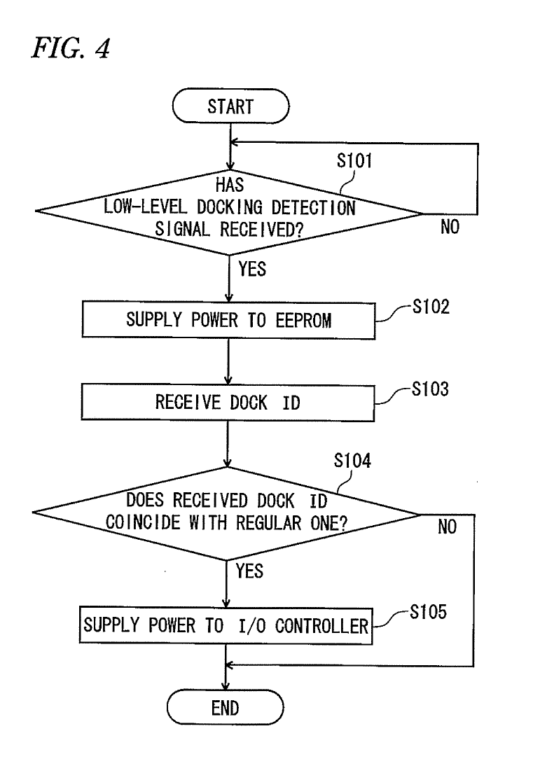

FIG. 4 illustrates a power control process of the electronic apparatus 1 according to the embodiment. First, at step S101, the embedded controller 18 judges whether or not it has received a low-level docking detection signal. If it is judged that a low-level docking detection signal has not been received (S101: no), step S101 is executed again.

On the other hand, if judging that a low-level docking detection signal has been received (S101: yes), at step S102 the embedded controller 18 causes supply of power to the EEPROM 104.

At step S103, the embedded controller 18 receives a dock ID 105 and communicates it to the BIOS 32. At step S104, the BIOS 32 judges whether the dock ID 105 received from the embedded controller 18 coincides with the dock ID 15 stored in the BIOS-ROM 14.

If it is judged that the received dock ID 105 does not coincide with the dock ID 15 stored in the BIOS-ROM 14 (S104: no), the power control process is finished. That is, no power is supplied to the terminal that is connected to the I/O controller 103.

On the other hand, if it is judged that the received dock ID 105 coincides with the dock ID 15 stored in the BIOS-ROM 14 (S104: yes), at step S105 the BIOS 32 supplies power to the terminal that is connected to the I/O controller 103 by controlling the power circuit 21. That is, supply of power to the I/O controller 103 is started.

As described above, according to the above-configured embodiment, the electronic apparatus 1 does not cause supply of power to the terminal that is connected to the I/O controller 103 unless a regular docking station 100 is connected to it. Thus, the electronic apparatus 1 is free of risk that an inadvertent short-circuit occurs at the connector 2.

In the embodiment, the BIOS 32 receives the dock ID 105 that is stored in the EEPROM 104 of the docking station 100 and authenticates it, that is, judges whether or not it coincides with the regular dock ID 15. If the authentication succeeds, the BIOS 32 causes a start of power supply to the terminal, connected to the I/O controller 103 of the docking station 100, of the connector 2. If not, the BIOS 32 does not cause a start of power supply.

That is, when a low-level docking detection signal is detected because of inadvertent contact of a foreign object to the connector 2, no dock ID 105 is received and hence supply of power to the terminal, connected to the I/O controller 103, of the connector 2 is started. In other words, no power is supplied to the terminal, connected to the I/O controller 103, of the connector 2 unless a regular docking station 100 is connected to the electronic apparatus 1. With this configuration, the number of terminals of the connector 2 to which power may be supplied unnecessarily can be reduced. Furthermore, an inadvertent short-circuit at the connector 2 can be prevented and power saving of the electronic apparatus 1 can be attained.

Although the embodiment has been described above, the embodiment is just an example and should not restrict the scope of the invention. The novel embodiment may be practiced in other various forms, and part of it may be omitted, replaced by other elements, or changed in various manners without departing from the spirit and scope of the invention. These modifications will fall within the scope of Claims and its equivalents.

1. An electronic apparatus, comprising:
a first power supply module configured to supply power to a storage device provided in an external device when the external device is connected to the electronic apparatus;
a receiving module configured to receive, from the external device, identification information thereof; and
a second power supply module configured to supply power to an input/output control module of the external device if authentication of the identification information received by the receiving module succeeds.

2. The apparatus of claim 1,
wherein the second power supply module does not supply power to the input/output control module if the authentication the identification information received by the receiving module fails.

3. The apparatus of claim 1, further comprising:
a storage device configured to store identification information of a regular external device; and
a judging module configured to judge whether or not the identification information received by the receiving module coincides with the identification information stored in the storage device,
wherein the second power supply module supplies power to input/output control module if the judging module judges that the identification information received by the receiving module coincides with the identification information stored in the storage device.

4. A power supply control method, comprising:
supplying power to a storage device provided in an external device when the external device is connected to an electronic apparatus;
receiving, from the external device, identification information thereof; and
supplying power to an input/output control module of the external device if authentication of the received identification information succeeds, and abstaining from supplying power to the input/output control module if the authentication of the received identification information fails.

5. The method of claim 4, further comprising:
storing identification information of a regular external device; and
judging whether or not the received identification information coincides with the stored identification information of the regular external device,
wherein the power supply step supplies power to the input/output control module if the judging step judges that the received identification information coincides with the stored identification information of the regular external device.
